(19) United States
(12) Patent Application Publication
(10) Pub. No.: US 2019/0179068 A1
(43) Pub. Date: Jun. 13, 2019

(54) POLARIZING PLATE AND METHOD FOR LASER PROCESSING POLARIZING PLATE

(71) Applicant: KABUSHIKI KAISHA TOKAI RIKA DENKI SEISAKUSHO, Aichi (JP)

(72) Inventor: Mitsuru NARUSE, Aichi (JP)

(21) Appl. No.: 16/323,167

(22) PCT Filed: Jul. 31, 2017
(86) PCT No.: PCT/JP2017/027753

§ 371 Date: Feb. 4, 2019

(30) Foreign Application Priority Data
Aug. 9, 2016 (JP) 2016-156629

(51) Int. Cl. G02B 5/30; B23K 26/36; G02B 27/28

(52) U.S. Cl. CPC G02B 5/3025; G02B 27/286; B23K 26/36

(57) ABSTRACT

A method for laser-processing a polarizing plate includes forming a region in which polarization characteristics are eliminated at a portion of a polarizing film by irradiation with laser light, using a first protection film bonded to one surface of the polarizing film with a first bonding layer being interposed therebetween, and a second protection film bonded to the other surface of the polarizing film with a second bonding layer being interposed therebetween, and scanning ultrashort pulse laser light from above the first protection film so that the region is irradiated with the light to remove an inner portion from the first protection film to the second bonding layer.

The present application is a U.S. National Phase of PCT/JP2017/027753 filed on Jun. 31, 2017 claiming priority to Japanese Patent Application No. 2016-156629 filed on Aug. 9, 2016. The disclosure of the PCT Application is hereby incorporated by reference into the present Application.

### TECHNICAL FIELD

The present invention relates to a polarizing plate and a method for laser-processing the polarizing plate and, in particular, to a polarizing plate having a region in which polarization characteristics are eliminated by irradiation with ultrashort pulse laser light, and a method for laser-processing the polarizing plate.

### BACKGROUND ART

A display switching lamp is known which selectively displays one of different shapes etc. on the same display surface (see, e.g., JP S61/25002 Y).

The display switching lamp described in JP S61/25002 Y is composed of two light sources, two light source-polarizing panels respectively provided in front of the light sources and having polarization directions perpendicular to each other, and two display-polarizing panels which are overlapped and provided in front of the light source-polarizing panels and have polarization directions perpendicular to each other and each of which has a light transmitting portion formed by cutting out a shape, etc. The lamp switches the display by switching a turned-on light source between the two light sources.

In the meantime, a laminated type polarizing plate is known which is formed by bonding protection films to both surfaces of a polarizing film. To form the light transmitting portion described in JP S61/25002 Y in the laminated type polarizing plate, e.g., a laser marking method described in JP H8/132258 A may be used.

The laser marking method described in JP H8/132258 A uses a marking sheet having a colored layer formed of a vapor-deposited aluminum layer with high laser light absorption between a transparent adhesive layer formed of acrylic-based adhesive with high transmittance to laser light and a transparent layer formed of polyester film with high transmittance to laser light, and only a predetermined portion of the colored layer is removed by irradiation with laser light to form a marking portion.

### CITATION LIST

### Patent Literatures

JP S61/25002 Y
JP H8/132258 A

### SUMMARY OF INVENTION

### Technical Problem

However, when only the colored layer with high laser light absorption is laser-processed by the laser marking method described in JP H8/132258 A, and if release of vaporized or sublimed components is blocked by the transparent adhesive layer and the transparent protection layer and remain inside the colored layer, it is difficult to laser-process the colored layer perfectly.

In this case, to form the light transmitting portion described in JP S61/25002 Y in the laminated type polarizing plate which is formed by bonding the protection films to both surfaces of the polarizing film, it may be possible to use a method in which laser light is radiated from above the protection film to cause partial evaporation of both the protection films and the polarizing film so that the evaporated portion is left as a characteristic-removed portion not having polarization characteristics. However, it is difficult to deeply laser-process the polarizing film since it is necessary to avoid detachment of an island portion separated by the characteristic-removed portion and isolated from the main portion of the protection films and the polarizing film.

It is an object of the invention to provide a polarizing plate with improved laser processability and a method for laser-processing the polarizing plate.

### Solution to Problem

According to an embodiment of the invention, a polarizing plate and a method for laser-processing the polarizing plate described in [1] to [6] below are provided.

[1] A method for laser-processing a polarizing plate, comprising:
forming a region in which polarization characteristics are eliminated at a portion of a polarizing film by irradiation with laser light;
using a first protection film bonded to one surface of the polarizing film with a first bonding layer being interposed therebetween, and a second protection film bonded to the other surface of the polarizing film with a second bonding layer being interposed therebetween; and
scanning ultrashort pulse laser light from above the first protection film so that the region is irradiated with the light to remove an inner portion from the first protection film to the second bonding layer.
   [2] The method for laser-processing a polarizing plate according to [1], wherein the removing of the inner portion from the first protection film to the second bonding layer is conducted such that a bottomed hole bottomed in the second bonding layer is formed and an island portion of the first protection film and the polarizing film isolated by the hole is left attached to the second protection film.
   [3] The method for laser-processing a polarizing plate according to [1] or [2], wherein a thickness of the second bonding layer is larger than a thickness of the first bonding layer.
   [4] The method for laser-processing a polarizing plate according to [1] or [2], wherein the first protection film comprises a material having lower transmittance to laser wavelength of the ultrashort pulse laser light and lower heat resistance than the second protection film.
   [5] The method for laser-processing a polarizing plate according to [1] or [2], wherein the second protection film is formed thicker than the first protection film.
   [6] A polarizing plate processed by the laser-processing method according to any one of [1] to [5], wherein the region comprises a light transmitting portion that transmits illumination light, and a shape of the light transmitting portion is displayed by an illumination.

### Advantageous Effects of Invention

According to an embodiment of the invention, a region in which the polarization function is eliminated can be stably formed by using ultrashort pulse laser light.

### BRIEF DESCRIPTION OF DRAWINGS

FIG. 1A is a plan view showing in a polarizing plate in an embodiment.

FIG. 1B is a cross sectional view taken along a line 1b-1b in FIG. 1A.

FIG. 2A is a plan view showing in a polarizing film.

FIG. 2B is a side view showing in the polarizing film.

FIG. 3A is an explanatory cross-sectional view showing a method for laser-processing the polarizing plate.

FIG. 3B is an explanatory cross-sectional view showing the method for laser-processing the polarizing plate.

### DESCRIPTION OF EMBODIMENTS

A preferred embodiment of the invention will be specifically described below based on the drawings. In the following description, a surface of the polarizing plate on the front side is defined as a front surface and a surface of the polarizing plate on the back side is defined as a back surface.

### General Configuration of Polarizing Plate

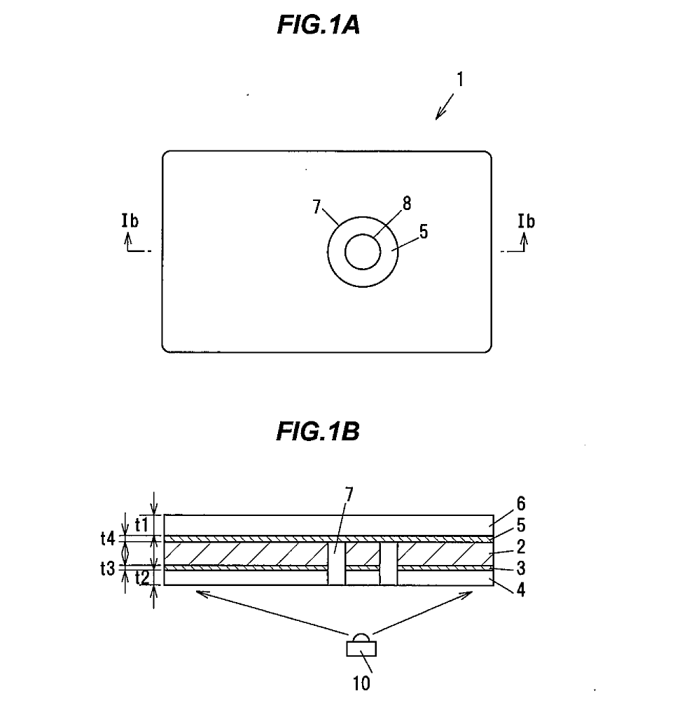

An example of a typical polarizing plate in the present embodiment is indicated generally by the reference numeral 1 in FIGS. 1A and 1B. The polarizing plate 1 is suitably used for various illuminated display devices which illuminate and display images indicating operations and functions, etc., on, e.g., instrument panel, heater control panel or switch knob, etc., mounted on various vehicles, even though the intended use is not specifically limited.

The polarizing plate 1 is formed of a laminated body which has a polarizing film 2, a first protection film 4 provided on one surface (the back surface) of the polarizing film 2 via a first bonding layer 3, and a second protection film 6 provided on the other surface (the front surface) of the polarizing film 2 via a second bonding layer 5. The polarizing film 2 serves as a polarizing layer, and the first and second protection films 4 and 6 serve as protective films for protecting the polarizing layer.

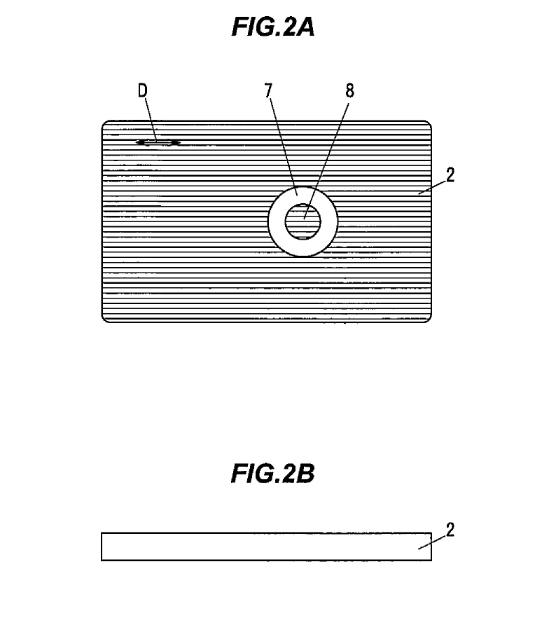

To form the polarizing film 2, a resin containing iodine or organic dye adsorbed to its polymer chains is stretched in, e.g., a stretching direction D to develop polarization characteristics of reflecting or absorbing light polarized in the stretching direction D, as shown in FIGS. 2A and 2B. Light having a polarized component parallel to the stretching direction D is reflected or absorbed by the polarizing film 2 and thus does not pass through the polarizing film 2.

On the other hand, light having a polarized component perpendicular to the stretching direction D passes through the polarizing film 2. A light source 10 used in the example shown in the drawing emits illumination light having a polarization direction parallel to the stretching direction D. The light source 10 is not specifically limited and is an LED, etc., mounted on a circuit board (not shown).

On the back side of the polarizing plate 1, a predetermined portion of the first protection film 4 and the polarizing film 2 is removed by irradiation with laser light and a light transmitting portion 7 is formed. The light transmitting portion 7 can be a bottomed hole formed by removing an inner portion from the first protection film 4 on the back side of the polarizing film 2 to the second bonding layer 5 on the front side of the polarizing film 2, so that the removed region does not penetrate the second protection film 6 on the front side of the polarizing film 2.

The light transmitting portion 7 is a region in which the polarizing function is eliminated, hence, light is not blocked. On the other hand, the remaining region of the polarizing plate 1 (a region other than the light transmitting portion 7) has the polarizing function and does not transmit illumination light from the light source 10.

Light is not blocked in the light transmitting portion 7 which is a region from which polarization characteristics are eliminated. Thus, the light transmitting portion 7 is a light transmitting region which transmits illumination light and serves as a design portion for showing a letter/character, number, shape, symbol or pattern, etc., indicating an operation or a function, etc. When the back surface of the polarizing plate 1 is illuminated with illumination light, the illumination light passes through the light transmitting portion 7 and the shape of the light transmitting portion 7 is illuminated and displayed.

The resin used to form the polarizing film 2 can be a common material which has a lower laser light absorption than the first and second protection films 4 and 6. For example, the polarizing film 2 is formed of, e.g., polyvinyl alcohol (PVA)-based resin.

The resin used to form the first protection film 4 can be a material having a higher laser light absorption than the polarizing film 2. For example, the first protection film 4 is formed of, e.g., triacetyl cellulose (TAC)-based resin.

The grade, etc., may be different between the first protection film 4 on the back side of the polarizing film 2 and the second protection film 6 on the front side of the polarizing film 2. The first protection film 4 can preferably be formed of a material having lower transmittance to the emitted laser wavelength and lower heat resistance than the second protection film 6. More preferably, a thickness t1 of the second protection film 6 on the front side of the polarizing film 2 is desirably set to be larger than a thickness t2 of the first protection film 4 on the back side of the polarizing film 2.

Any adhesive can be used as a material of the first bonding layer 3 on the back side of the polarizing film 2 and the second bonding layer 5 on the front side of the polarizing film 2, but it is preferable to use an adhesive of which components do not cause degradation of polarization characteristics. The adhesive which can be used is, e.g., a water-based adhesive containing a PVA-based resin.

To prevent damage, etc., on the second protection film 6 on the front side of the polarizing film 2 during irradiation with laser light, it is preferable to control a thickness t3 of the first bonding layer 3 on the back side of the polarizing film 2 and a thickness t4 of the second bonding layer 5 on the front side of the polarizing film 2. More preferably, the thickness t4 of the second bonding layer 5 on the front side of the polarizing film 2 is set to be larger than the thickness t3 of the first bonding layer 3 on the back side of the polarizing film 11.

Ultrashort pulse laser light is desirably used as laser light to remove a predetermined portion of the first protection film 4 and the polarizing film 2 to form the light transmitting portion 7 since precision micromachining is realized without causing thermal fusion.

The ultrashort pulse laser light is picosecond laser light with a pulse width on the order of picoseconds, or femtosecond laser light with a pulse width on the order of femtoseconds. The picosecond laser light has, e.g., a pulse width of not more than 500 sp and a wavelength of not more than 1000 nm, but the laser light is not limited thereto as long as it is ultrashort pulse laser light.

### Method for Laser-Processing the Polarizing Plate

In the meantime, mechanical cutting process and irradiation with pulsed laser light having an infrared wavelength are not preferable since the second protection film 6 on the front side of the polarizing film 2 is damaged. Laminated films having different laser light absorptions are likely to shrink and deform, etc., due to heat generated by irradiation with laser light, and it is not possible to achieve a desired removal process such as, e.g., that shown in FIG. 1A.

The light transmitting portion 7 of the polarizing plate 1, which is configured as described above, is efficiently formed by laser-processing using ultrashort pulse laser light L.

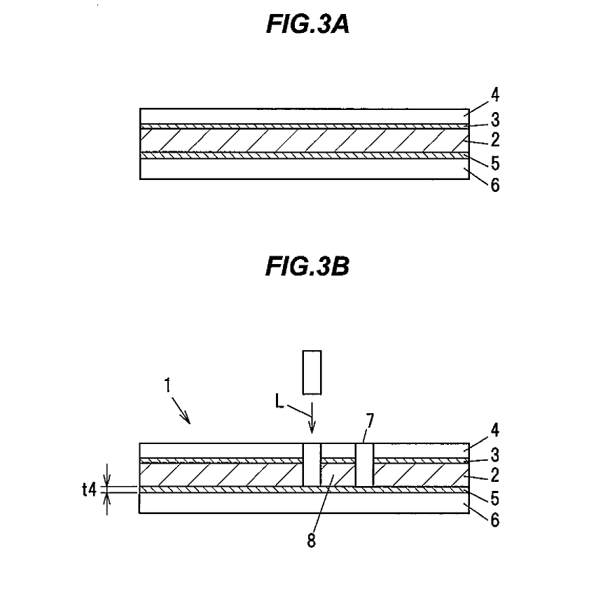

The method for laser-processing the polarizing plate 1 is effectively achieved by going through a series of steps, including a laminated body-forming step for laminating the protection films 4 and 6 on the both surfaces of the polarizing film 2 via the bonding layers 3 and 5, a polarizing plate-forming step for imparting polarization characteristics to the polarizing film 2, and a light transmitting portion-forming step for forming the light transmitting portion 7 on the polarizing plate 1, as shown in FIGS. 3A and 3B.

### Laminated Body-Forming Step

To manufacture the polarizing plate 1, firstly, a water-based adhesive containing a PVA-based resin, which constitutes the bonding layers 3 and 5, is applied by a usual method to each of both surfaces of a PVA-based resin constituting the polarizing film 2, as shown in FIG. 3A. A TAC resin constituting the protection films 4 and 6 is then bonded to each of the bonding layers 3 and 5, and a laminated body is thereby formed.

### Polarizing Plate-Forming Step

Next, the obtained laminated body is dyed, cross-linked, stretched, cleaned and heated, etc., by usual methods, thereby forming the polarizing plate 1 having the polarizing film 2, the first protection film 4 provided on the back surface of the polarizing film 2 via the first bonding layer 3, and the second protection film 6 provided on the front surface of the polarizing film 2 via the second bonding layer 5.

### Light Transmitting Portion-Forming Step

Next, as shown in FIG. 3B, the ultrashort pulse laser light L is scanned according to the laser-processing parameters such as a predetermined pulse width, wavelength and energy density on the surface so that a predetermined region is irradiated with the ultrashort pulse laser light L from above the first protection film 4 on the back side of the polarizing film 2. By partially removing the first protection film 4, the first bonding layer 3 and the polarizing film 2 in a certain region, the light transmitting portion 7 is formed at the inner portion from the first protection film 4 to the second bonding layer 5.

In case that swarf, etc., generated from the first protection film 4 is deposited in a hole-shaped processed portion constituting the light transmitting portion 7 during removal of the first protection film 4 on the back side of the polarizing film 2, the swarf, etc., is removed by, e.g., blowing air during or after the laser-processing.

With the laser-processing using the ultrashort pulse laser light L, it is possible to remove both the polarizing film 2 and the first protection film 4 on the back side of the polarizing film 2 while leaving the second protection film 6 on the front side of the polarizing film 2 by controlling the thickness t4 of the second bonding layer 5 on the front side of the polarizing film 2.

By using such laser-processing method to form an island portion 8 which is separated by the hole-shaped processed portion constituting the light transmitting portion 7 and isolated from the main portion of the first protection film 4 and the polarizing film 2, the island portion 8 can be joined to the second protection film 6 on the front side of the polarizing film 2 (bonded to the second protection film 6) and prevented from coming off and being detached.

Use of the ultrashort pulse laser light L can prevent material shrinkage due to heat generation. In addition, by removing not only the polarizing film 2 but also the first protection film 4 on the back side of the polarizing film 2, it is possible to eject swarf, etc., of the removed polarizing film 2 out of the light transmitting portion 7.

The following laser-processing conditions are preferable for partially removing the first protection film 4, the first bonding layer 3 and the polarizing film 2 in the certain region by irradiation with the ultrashort pulse laser light L.

(1) The output power of the ultrashort pulse laser light L is adjusted.
(2) The resin constituting the second protection film 6 on the front side of the polarizing film 2 is formed thicker than the resin constituting the first protection film 4 on the back side of the polarizing film 2.
(3) The second bonding layer 5 on the front side of the polarizing film 2 is applied thicker than the first bonding layer 3 on the back side of the polarizing film 2.
(4) Damage, etc., on the second protection film 6 on the front side of the polarizing film 2 is prevented by adjusting the output power of the ultrashort pulse laser light L or the thickness of the second bonding layer 5 on the front side of the polarizing film 2.

As a result, the region, in which the inner portion from the first protection film 4 on the back side of the polarizing film 2 to the second bonding layer 5 on the front side of the polarizing film 2 is removed, can be formed as a bottomed hole which has a bottom within the second bonding layer 5 and does not penetrate the second protection film 6 on the front side of the polarizing film 2. In addition, the island portion 8 is connected by the second protection film 6 and is prevented from coming off and being detached.

### Effects of the Embodiment

The polarizing plate 1 and the method for laser-processing polarizing plate 1 in the present embodiment achieve the following effects, in addition to the effects described above.

Since resins excellent in heat resistance, such as PVA-based resin and TAC-based resin, can be used as materials of the polarizing plate 1, the polarizing plate 1 is applicable to automotive components required to have heat resistance.

By using the light source 10 having a polarization direction parallel or perpendicular to the stretching direction D of the polarizing plate 1, it is possible to selectively display images on the same position and thereby possible to reduce the space for the illuminated display structure.

Since the structure is simple, it is possible to reduce the cost.

The polarizing plate 1, in which the films 2, 4 and 6 having different laser light absorptions are laminated, can be laser-processed to from the light transmitting portion 7 with high quality and high efficiency.

Since it is possible to prevent quality defects such as damage on films, yield increases and it is thus possible to obtain high productivity.

Although the polarizing plate 1 of the invention has been described to be used for automobile in the example showing the representative configuration, the invention is not limited thereto and it is obviously effectively applicable to, e.g., various work vehicles such as construction machinery or agricultural machinery.

It is obvious that the polarizing plate 1 is applicable to, e.g., image display device such as liquid-crystal panel, or various terminal devices of gaming machine, personal computer and mobile phone, etc.

To achieve the initial object of the invention, the number, position and configuration, etc., of the light transmitting portion 7 of the polarizing plate 1 can be appropriately selected according to, e.g., the intended purpose, etc.

As understood from the description above, the invention according to claims is not to be limited to the representative embodiment and the example shown in the drawings of the invention. Therefore, it should be noted that all combinations of the features described in the embodiment and the example shown in the drawings are not necessary to solve the problem of the invention.

### REFERENCE SIGNS LIST

1 POLARIZING PLATE
2 POLARIZING FILM
3 FIRST BONDING LAYER
4 FIRST PROTECTION FILM
5 SECOND BONDING LAYER
6 SECOND PROTECTION FILM
7 LIGHT TRANSMITTING PORTION
8 ISLAND PORTION

1. A method for laser-processing a polarizing plate, comprising:
forming a region in which polarization characteristics are eliminated at a portion of a polarizing film by irradiation with laser light;
using a first protection film bonded to one surface of the polarizing film with a first bonding layer being interposed therebetween, and a second protection film bonded to the other surface of the polarizing film with a second bonding layer being interposed therebetween; and
scanning ultrashort pulse laser light from above the first protection film so that the region is irradiated with the light to remove an inner portion from the first protection film to the second bonding layer.

2. The method for laser-processing a polarizing plate according to claim 1, wherein the removing of the inner portion from the first protection film to the second bonding layer is conducted such that a bottomed hole bottomed in the second bonding layer is formed and an island portion of the first protection film and the polarizing film isolated by the hole is left attached to the second protection film.

3. The method for laser-processing a polarizing plate according to claim 1, wherein a thickness of the second bonding layer is larger than a thickness of the first bonding layer.

4. The method for laser-processing a polarizing plate according to claim 1, wherein the first protection film comprises a material having lower transmittance to laser wavelength of the ultrashort pulse laser light and lower heat resistance than the second protection film.

5. The method for laser-processing a polarizing plate according to claim 1, wherein the second protection film is formed thicker than the first protection film.

6. A polarizing plate processed by the laser-processing method according to claim 1, wherein the region comprises a light transmitting portion that transmits illumination light, and a shape of the light transmitting portion is displayed by an illumination.

7. The method for laser-processing a polarizing plate according to claim 2, wherein a thickness of the second bonding layer is larger than a thickness of the first bonding layer.

8. The method for laser-processing a polarizing plate according to claim 2, wherein the first protection film comprises a material having lower transmittance to laser wavelength of the ultrashort pulse laser light and lower heat resistance than the second protection film.

9. The method for laser-processing a polarizing plate according to claim 2, wherein the second protection film is formed thicker than the first protection film.

10. A polarizing plate processed by the laser-processing method according to claim 2, wherein the region comprises a light transmitting portion that transmits illumination light, and a shape of the light transmitting portion is displayed by an illumination.

11. A polarizing plate processed by the laser-processing method according to claim 3, wherein the region comprises a light transmitting portion that transmits illumination light, and a shape of the light transmitting portion is displayed by an illumination.

12. A polarizing plate processed by the laser-processing method according to claim 4, wherein the region comprises a light transmitting portion that transmits illumination light, and a shape of the light transmitting portion is displayed by an illumination.

13. A polarizing plate processed by the laser-processing method according to claim 5, wherein the region comprises a light transmitting portion that transmits illumination light, and a shape of the light transmitting portion is displayed by an illumination.
